(19) United States
(12) Patent Application Publication
(10) Pub. No.: US 2007/0247517 A1
(43) Pub. Date: Oct. 25, 2007

(54) Method and apparatus for producing a fused image

(75) Inventors: Chao Zhang, Belle Mead, NJ (US); John Southall, Philadelphia, PA (US); Theodore A. Camus, Marlton, NJ (US)

Correspondence Address: PATENT DOCKET ADMINISTRATOR;LOWENSTEIN SANDLER P.C., 65 LIVINGSTON AVENUE, ROSELAND, NJ, 07068, US

(73) Assignee: Sarnoff Corporation

(21) Appl. No.: 11/209,969

(22) Filed: Aug. 23, 2005

Related U.S. Application Data
(60) Provisional application No. 60/603,607, filed on Aug. 23, 2004.

(51) Int. Cl. H04N 9/64

(52) U.S. Cl. 348/30; 348/33

(57) ABSTRACT

A method and apparatus for producing a fused image is described. In one embodiment, a first image at a first wavelength and a second image at a second wavelength are generated. Next, range information is generated and subsequently used to warp the first image in a manner that correlates to the second image. In turn, the warped first image is fused with the second image to produce the fused image.

### CROSS-REFERENCE TO RELATED APPLICATIONS

This application claims the benefit of U.S. provisional patent application Ser. No. 60/603,607, filed Aug. 23, 2004, the entire disclosure of which is herein incorporated by reference.

### BACKGROUND OF THE INVENTION

1. Field of the Invention

Embodiments of the present invention generally relate to a method and apparatus for generating imagery data, and, in particular, for producing a fused image.

2. Description of the Related Art

Presently, fusion programs utilize simple homographic models for image alignment with the assumption that at least two sensors (e.g., cameras) are positioned next to each other in a manner that parallax conditions are negligible. However, if two sensors are separated such that the distance of their baseline is comparable to the distance from one of cameras to the target object in a scene, parallax will occur. Parallax may be defined as the apparent displacement (or difference of position) of a target object, as seen from two different positions or points of view. Alternatively, it is the apparent shift of an object against a background due to a change in observer position. In the event two fusion sensors are co-located (i.e., virtually on top of each other) and have parallel optical axes, the parallax condition is negligible. However, when sensors are separated by a substantial distance (e.g., a lateral separation of 30 centimeters or a vertical separation of 1 meter), parallax will be exhibited. Thus, the images captured by the sensors will demonstrate depth-dependent misalignment, thus impairing the quality of the fused image. Notably, current fusion programs are unable to account for the positioning of the sensors and will fail to produce a reliable fused image in this scenario.

Thus, there is a need for a method and apparatus for producing a fused image in instances where parallax conditions are exhibited.

### SUMMARY OF THE INVENTION

In one embodiment, a method and apparatus for producing a fused image is described. More specifically, a first image at a first wavelength and a second image at a second wavelength are generated. Next, range information is generated and subsequently used to warp the first image in a manner that correlates to the second image. In turn, the warped first image is fused with the second image to produce the fused image.

### BRIEF DESCRIPTION OF THE DRAWINGS

So the manner in which the above recited features of embodiments of the present invention are obtained and can be understood in detail, a more particular description of embodiments of the present invention, briefly summarized above, may be had by reference to said embodiments thereof, illustrated in the appended drawings. It is to be noted; however, the appended drawings illustrate only typical embodiments of the present invention and are therefore not to be considered limiting of its scope, for the present invention may admit to other equally effective embodiments, wherein:

FIG. 1 is a block diagram depicting an exemplary embodiment of an image processing system in accordance with the present invention;

FIG. 2 illustrates a diagram of the operation of a first embodiment of the production of a fused image;

FIG. 3 illustrates a diagram of the operation of a second embodiment of the production of a fused image;

FIG. 4 illustrates a diagram of the operation of a third embodiment of the production of a fused image;

FIG. 5 illustrates a flow diagram depicting an exemplary embodiment of a method for producing a fused image in accordance with one or more aspects of the invention; and

FIG. 6 is a block diagram depicting an exemplary embodiment of a computer suitable for implementing the processes and methods described herein.

### DETAILED DESCRIPTION

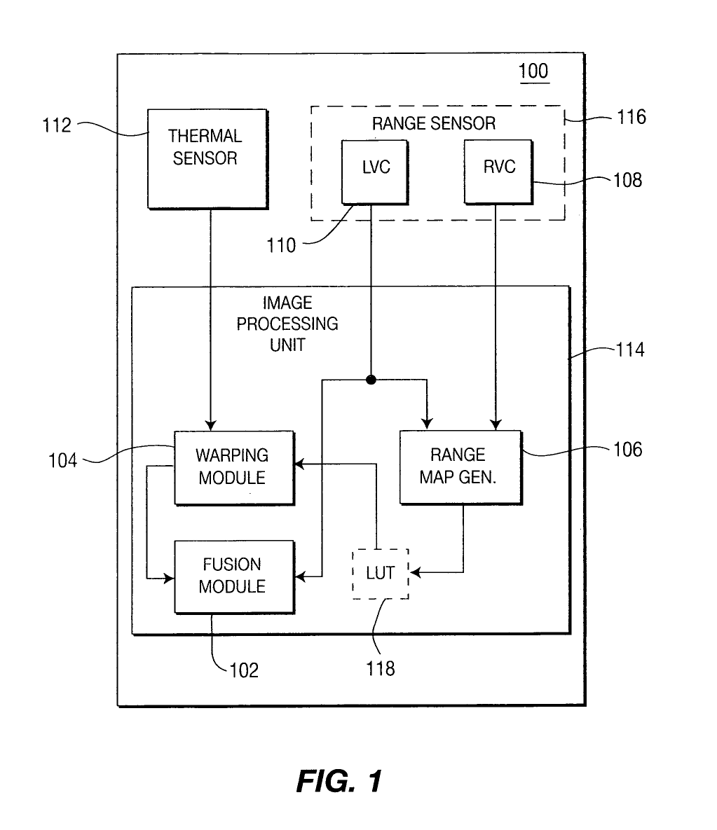

Embodiments of the present invention are directed to a method and apparatus for producing a fused image in the event parallax conditions are exhibited. FIG. 1 illustrates a block diagram depicting an exemplary embodiment of an image fusion system 100 in accordance with the present invention. The system comprises a range sensor 116, a thermal sensor 112, and an image processing unit 114. The range sensor 116 may comprise any type of device(s) that can be used to determine depth information of a target object in a scene. For example, the range sensor 116 may comprise a Radio Detection and Ranging (RADAR) sensor, a Laser Detection and Ranging (LADAR) sensor, a pair of stereo cameras, and the like (as well as any combinations thereof). Similarly, the thermal sensor 112 may comprise a near-infrared (NIR) sensor (e.g., wavelengths from 700 nm to 1300 nm), a far-infrared (FIR) sensor (e.g., wavelengths of over 3000 nm), an ultraviolet sensor, and the like. While the current embodiment uses both visible stereo cameras and a thermal “night vision” sensor, it is understood that more generally the invention applies to any combination of imaging wavelengths, whether reflected or radiated, as may be desirable or required by the application.

As depicted in FIG. 1, the range sensor 116 may comprise a pair of stereo visible cameras, namely, a left visible camera (LVC) 110 and a right visible camera (RVC) 108 in one embodiment. A visible camera, or visible light camera, may be any type of camera that captures images within the visible light spectrum. The thermal sensor 112 may include any device that is capable of capturing thermal imagery such as, but not limited to, an infrared (IR) sensor. The image processing unit 114 comprises a plurality of modules that produce a fused image from the images captured from the thermal sensor 112 and the range sensor 116. The image processing unit 114 may be embodied as a software program capable of being executed on a personal computer, processor, controller, and the like. Alternatively, the image processing unit 114 may instead comprise a hardware component such as an application specific integrated circuit, a peripheral component interconnect (PCI) board, and the like. In one embodiment, the image processing unit 114 includes a range map generation module 106, a warping module 104, a lookup table (LUT) 118, and a fusion module 102.

The range map generation module 106 is responsible for receiving imagery input from the range sensor 116 and producing a two-dimension depth map (or range map). In one embodiment, the generation module 106 may be embodied as a stereo imagery processing software program or the like. The warping module 104 is the component that is responsible for the warping process. The LUT 118 contains transformation data that is utilized by the warping module 104. The fusion module 102 is the component that obtains images from the warping module 104 and/or the thermal sensor 112 and produces a final fused image.

In one embodiment of the present invention, the left visible camera 110 and the right visible camera 108 each capture a respective image (i.e., LVC image 210 and RVC image 208). These images are then provided to the range map generator 106 to produce a two-dimensional range map 206. Although the range map generator 106 is shown to be part of the image processing unit 114 in FIG. 1, this module may be located within the range sensor 116 in an alternative embodiment.

The range map 206 produced by the range map generator 106 typically comprises depth information that represents the distance a particular target object (or objects) in the captured scene is positioned from the visible cameras. The range map is then provided to the LUT 118 to determine the requisite transformation data. In one embodiment, the LUT 118 contains a multiplicity of transformation matrices that are categorized based on certain criteria, such as the depth of a moving target. For example, a range map may be used to provide the depth of a target object, which in turn can be used as a parameter to select an appropriate transformation matrix. Those skilled in the art recognize that additional parameters may be used to select the appropriate transformation matrix. One example of a transformation matrix is shown below:

$$( \begin{matrix}{x}_{tv} \\ {y}_{tv}\end{matrix} ) = [ \begin{matrix}\frac{{z}_{ir}}{{z}_{tv}} \cdot \frac{{f}_{tv}^{x}}{{f}_{ir}^{x}} & 0 & - \frac{{z}_{ir}}{{z}_{tv}} \cdot \frac{{f}_{tv}^{x}}{{f}_{ir}^{x}} \cdot {c}_{ir}^{x} + {c}_{tv}^{x} - \frac{{d}_{x} {f}_{tv}^{x}}{{z}_{tv}} \\ 0 & \frac{{z}_{ir}}{{z}_{tv}} \cdot \frac{{f}_{tv}^{y}}{{f}_{ir}^{y}} & - \frac{{z}_{ir}}{{z}_{tv}} \cdot \frac{{f}_{tv}^{x}}{{f}_{tr}^{x}} \cdot {c}_{ir}^{y} + {c}_{tv}^{y} + \frac{{d}_{y} {f}_{tv}^{y}}{{z}_{tv}}\end{matrix} ] ( \begin{matrix}{x}_{ir} \\ {y}_{ir} \\ 1\end{matrix} )$$

In this particular equation, zᵢᵣ represents the distance from the IR sensor to a target along the z-axis, zₜᵥ represents the distance from a visible camera (e.g., the LVC) along the z-axis, z_{d} represents the distance from the visible camera to the IR sensor along the z-axis, fₜᵥ represents the focal length of the visible camera, fᵢᵣ represents the focal length of the infra-red camera, cᵢᵣ represents the infra-red camera image center, cₜᵥ represents the visible camera image center, xᵢᵣ represents the x coordinate of a point in the infra-red camera image, yᵢᵣ represents the y coordinate of the same point in the infra-red camera image, xₜᵥ represents the x coordinate of a point in the visible camera image, and yₜᵥ represents the y coordinate of the same point in the visible camera image.

Once selected, the transformation matrix is provided to the warping module 104 along with images from the fusion cameras (two sensors operating at two different wavelengths), e.g., the LVC 110 and the IR sensor 112. The warping module 104 then warps the IR sensor image 212 to correlate with the LVC image 210 using the transformation data, a process well known to one skilled in the art (for example, see U.S. Pat. No. 5,649,032). Notably, the warping module 104 accomplishes this by generating pyramids for both the IR sensor image 212 and the LVC image 210. Thus, the captured LVC and IR images initially do not have to be the same size since the images can be scaled appropriately as is well known to one skilled in the art (e.g., see U.S. Pat. No. 5,325,449). After the sensor image 212 is warped, the fusion module 102 fuses the warped IR sensor image with the LVC image 210 in a manner that is also well known to those skilled in the art (e.g., see U.S. Pat. No. 5,488,674).

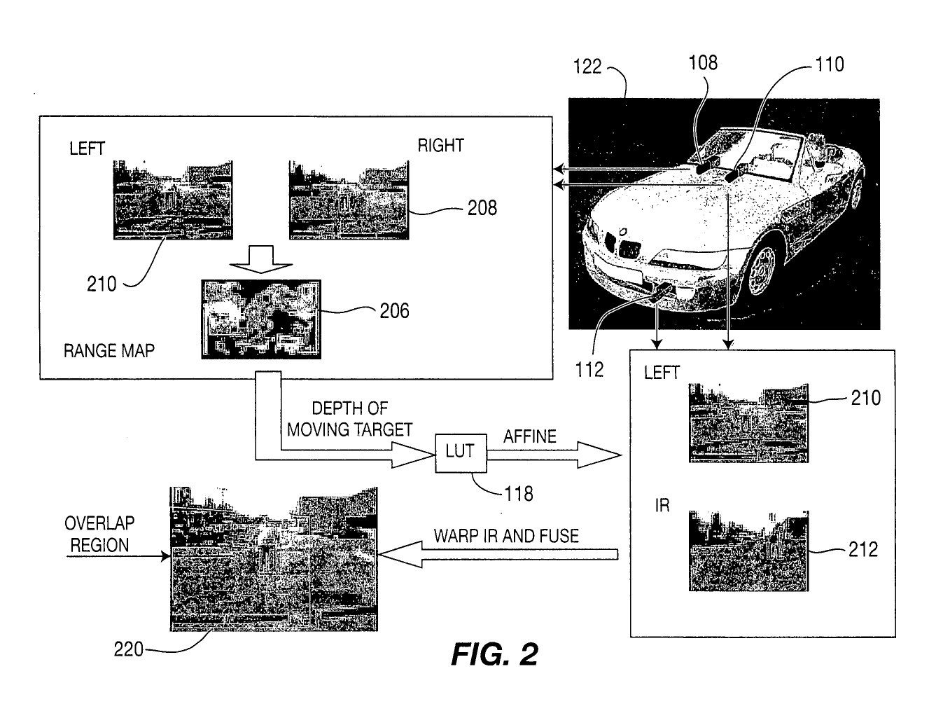

FIG. 2 depicts the operation of one embodiment of the present invention. Specifically, FIG. 2 illustrates a planar based alignment approach that utilizes a range map that represents a captured image using constant depth information. In this embodiment, which utilizes an automobile as a platform, a pair of visible stereo cameras (i.e., left visible camera 110 and right visible camera 108) may be separately mounted in the center portion of a windshield of an automobile 122. This embodiment also utilizes an infrared (IR) sensor 112 that is positioned on or near the automobile's bumper. The IR sensor 112 should be positioned horizontally close to one of the visible stereo cameras (e.g., the left visible camera 110) in order to obtain a larger area of overlap to aid in the fusion process. Notably, the separation of the two sensors (one of the visible cameras and the IR sensor) creates a parallax effect that may cause a depth-dependent misalignment in the respective camera images. In one embodiment, the pair of visible stereo cameras is genlocked. Similarly, the fusion sensors (i.e., the left visible camera 110 and the IR sensor 112) are also genlocked.

Initially, the left and right visible cameras capture an image (e.g., left camera image 210 and right camera image 208) from different angles due to their respective locations. Once these images are taken, a stereo imagery program computes and generates a two-dimensional range map. After this range map is calculated, it is provided as input to a look-up table (LUT) 118 that may be stored in memory or firmware. Using the appropriate data from the range map (e.g., the depth of a target), the LUT, 118 produces the appropriate transformation data, such as a transformation matrix equation, that may be used to warp the sensor image 212. Each element within the transformation matrix is a function of the depth (e.g., distance of target(s) to range sensor 116) of the objects in the image. The transformation matrix can be used to calculate the necessary amount of shifting that is required to align the sensor image 212 with the LVC image 210. It should be noted the present invention is not limited as to which visible image is used.

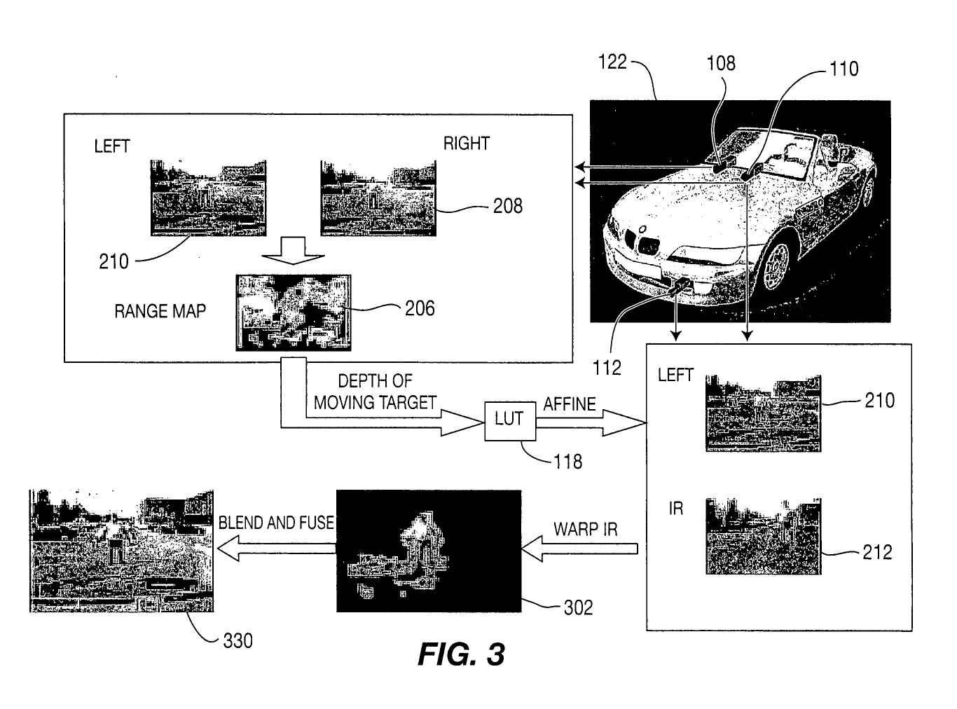

FIG. 3 depicts the operation of a second embodiment of the present invention. Specifically, FIG. 3 illustrates an approach that only utilizes the depth information of a “blob”, or a target object, present in a particular image. This embodiment is not unlike the approach described above with the exception that a certain designated portion of the IR image, instead of the entire IR image, is warped and fused. Notably, the procedure is identical to the process described in FIG. 2 until the warping module 104 has received the transformation data from the LUT 118. At this point in the process, the warping device 102 selects a target object or “blob” (i.e., a group of pixels at a constant depth, or close to constant depth) in the IR image. This particular embodiment uses the concept of “depth bands,” considered to comprise all pixels in a range image whose range values lie between an upper and lower limit as appropriate for a given embodiment, to select the desired target object.

Once the target object selection is made, the warping module 104 warps the target object, or “blob”, with the coordinates of the image from the remaining fusion camera (e.g., the LVC 110). Once the IR image 212 has been warped, the fusion module 102 combines the warped image 302 and the LVC image 210 to produce a fused image 330. Occasionally, the resultant fused image exhibits sharp boundaries created from only warping and fusing the “target object” (see warped image 302). In these instances, the fusion module 102 blends the warped image in order to smooth out the discontinuous border effects in a manner that is well known in the art (e.g., see U.S. Pat. No. 5,649,032).

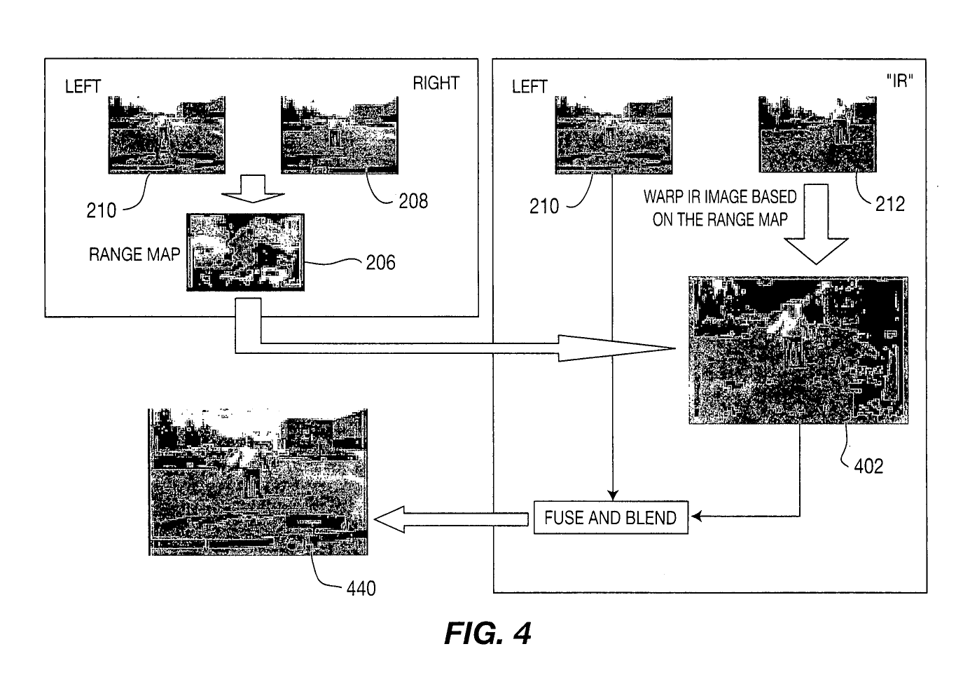

FIG. 4 depicts the operation of a third embodiment of the present invention. Specifically, FIG. 4 illustrates an approach that utilizes the depth information of each individual pixel present in the captured fusion images. This embodiment differs from the approaches described above in the sense that each individual pixel of the IR image 212, instead of the entire image (or an object of the IR image) as a whole, is warped in accordance with a separate transformation calculation. Thus, this embodiment does not utilize a lookup table to produce the requisite transformation data. Instead, the two-dimensional range map produced by the range map generation module 106 is used an applied on a pixel by pixel basis. By using the range map, the present invention utilizes depth information from every pixel. Namely, every portion of the IR image is warped using the range map on a pixel by pixel basis. Once this step is completed, the visible image from the remaining fusion camera (e.g., the LVC 110) is fused and blended with the warped IR image to produce the final fused image. Similar to the embodiment depicted in FIG. 3, the fused image may require blending in order to smooth out the borders between pixels, as well as any regions that may be missing data.

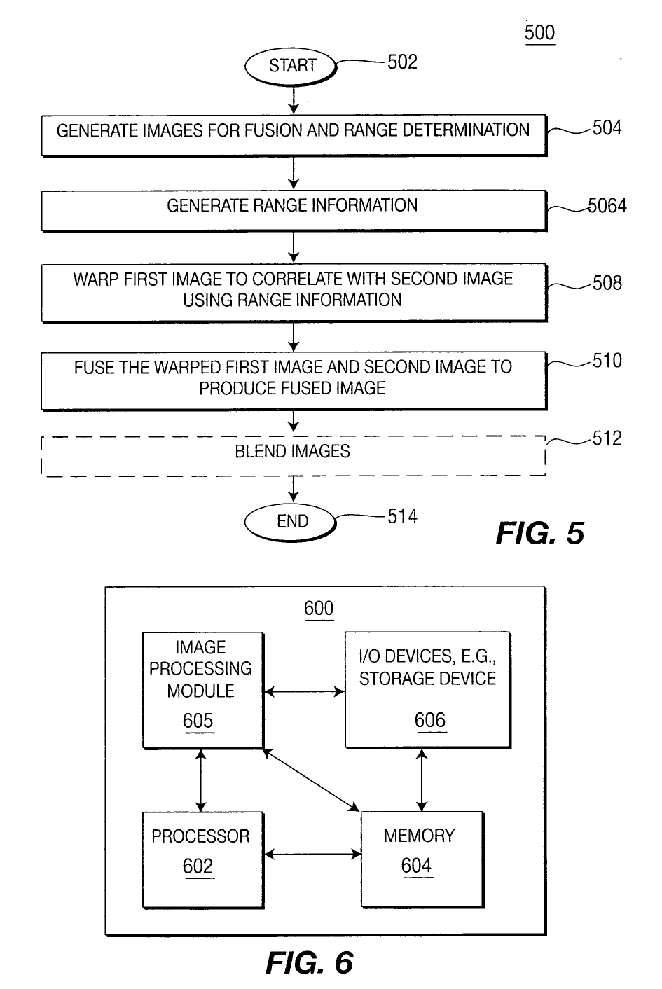

FIG. 5 depicts a flow diagram depicting an exemplary embodiment of a method 500 for utilizing depth information in accordance with one or more aspects of the invention. The method 500 begins at step 502 and proceeds to step 504 where images for both fusion and range determination are generated. In one embodiment, the fusion images comprise a first image and a second image. For example, the first image may be a thermal image 212 produced by an IR sensor 112 and the second image may be a visible image 210 produced by the LVC 110 of the range sensor 116. In this example, the second image is also one of a pair of visible images (along with RVC image 208) that are captured by the range sensor 116. However, the present invention is not so limited. If the range sensor 116 does not include a visible sensor, then the visible image can be provided by a third sensor. In another embodiment, the first sensor may include an ultraviolet sensor. More generally, both the first and second fusion images may be provided by any two sensors with differing, typically complementary, spectral characteristics and wavelength sensitivity.

At step 506, the range information is generated. In one embodiment, images obtained by the LVC 110 and the RVC 108 are provided to the range map generation module 106. The generation module 106 produces a two-dimensional range map that is used to compensate for the parallax condition. Depending on the embodiment, the range map generation process may be executed on the image processing unit 114 or by the range sensor 116 itself.

At step 508, the first image is warped. In one embodiment, the IR image 212 is provided to the warping module 104. The warping module 104 utilizes the range information produced by the generation module 106 to warp the IR image 212 into the coordinates of the visible image 210. In another embodiment, transformation data derived from the range information is utilized in the warping process. Notably, the range map is instead provided as input to a lookup table (LUT) 118. The LUT 118 then uses the depth information indicated on the range map as parameters to determine the transformation data needed to warp the IR image 212. This transformation data may be a transformation matrix specifically derived to compensate for parallax conditions exhibited by a target object or scene at a particular distance from the cameras comprising the range sensor 116.

At step 510, the first image and the second image are fused. In one embodiment, the fusion module 102 fuses the LVC image 210 with the warped IR image. As a result of this process, a fused image is produced. At step 512, the fused image may be optionally blended to compensate for sharp boundaries or missing pixels depending on the embodiment. The method 500 ends at step 514.

FIG. 6 depicts a high level block diagram of a general purpose computer suitable for use in performing the functions described herein. As depicted in FIG. 6, the system 600 comprises a processor element 602 (e.g., a CPU), a memory 604, e.g., random access memory (RAM) and/or read only memory (ROM), an image processing unit module 605, and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present image processing unit module or algorithm 605 can be loaded into memory 604 and executed by processor 602 to implement the functions as discussed above. As such, the present image processing unit algorithm 605 (including associated data structures) of the present invention can be stored on a computer readable medium or carrier, e.g., RAM memory, magnetic or optical drive or diskette and the like.

One implementation of the first embodiment of this invention is to run a stereo application and a fusion application separately on two vision processing boards, e.g., Sarnoff PCI Acadia™ boards (e.g., see U.S. Pat. No. 5,963,675). The stereo cameras (LVC 110 and RVC 108) are connected to the stereo board, and the LVC 110 and the IR sensor 112 are connected to the fusion board. A host personal computer (PC) connects both boards via a PCI bus. The range map is sent from the stereo board to the host PC. The host PC computes the warping parameters based on the nearest target depth from the range map and sends the result to the fusion board. The fusion application then warps the IR sensor image 212 and fuses it with the image from the LVC image 210.

The advantage of utilizing fused images is that objects within a given scene may be detected in a plurality of spectrums (e.g., infrared, ultraviolet, visible light spectrum, etc.). To illustrate, consider the scenario in which a person and a street sign are positioned in a parking lot at nighttime. Visible cameras mounted on an automobile are capable of capturing an image of the street sign in which the words of the sign could be read using the automobile's headlights. However, the visible cameras may not be able to detect the person if he was wearing dark colored clothing and/or was out of the range of the headlights. Conversely, a thermal image could readily capture the thermal image of the man due to his body heat, but would be unable to capture the street sign since its temperature was comparable to the surrounding environment. Furthermore, the lettering on the sign would not be detected by using the IR sensor. By combining the thermal image and a visible image using the fusion module, a resultant fused image containing both the person and the sign may be generated. The use of fused images is therefore extremely advantageous in automotive applications, such as collision avoidance and steering methods.

In addition to the benefits offered in automobile operations, this invention may also be used in a similar manner for other types of platforms or vehicles, such as boats, unmanned vehicles, aircrafts, and the like. Namely, this invention can provide assistance for navigating through fog, rain, or other adverse conditions. Similarly, fused images may also be utilized in different fields of medicine. For example, this invention may be able to assist doctors perform surgical procedures by enabling them to observe different depths of an organ or tissue.

In addition to mobile vehicles and objects, this invention is also suitable for static installations, such as security and surveillance applications (e.g., a security and surveillance camera system), where images from two cameras of differing spectral properties, that cannot be co-axially mounted, must be fused. For example, some applications may have tight space constraints due to pre-existing construction and co-axially mounting two cameras may not be possible.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for producing a fused image, comprising:
generating a first image at a first wavelength;
generating a second image at a second wavelength, wherein said second wavelength is different from said first wavelength;
generating range information;
warping said first image to correlate with said second image using said range information; and
fusing said warped first image with said second image to produce said fused image.

2. The method of claim 1, wherein said warping step comprises:
producing transformation data using said range information; and
warping said first image to correlate with said second image using said transformation data.

3. The method of claim 2, wherein said transformation data comprises a transformation matrix.

4. The method of claim 1, wherein said range information comprises a two-dimensional depth map.

5. The method of claim 1, wherein said first image comprises a thermal image.

6. The method of claim 1, wherein said second image comprises a visible image.

7. The method of claim 1, further comprising blending said fused image.

8. The method of claim 1, wherein said second image is used in generating said range information.

9. An apparatus for producing a fused image in a platform, comprising:
means for generating a first image at a first wavelength;
means for generating a second image at a second wavelength, wherein said second wavelength is different from said first wavelength;
means for generating range information;
means for warping said first image to correlate with said second image using said range information; and
means for fusing said warped first image with said second image to produce said fused image.

10. The apparatus of claim 9, wherein said warping means comprises:
means for producing transformation data using said range information; and
means for warping said first image to correlate with said second image using said transformation data.

11. The apparatus of claim 10, wherein said transformation data comprises a transformation matrix.

12. The apparatus of claim 9, wherein said range information comprises a two-dimensional depth map.

13. The apparatus of claim 9, wherein said first image comprises a thermal image.

14. The apparatus of claim 9, wherein said second image comprises a visible image.

15. The apparatus of claim 9, further comprising blending said fused image.

16. The apparatus of claim 9, wherein said platform is at least one of: an automobile, an airplane, a boat, an unmanned vehicle, or a security and surveillance camera system.

17. The apparatus of claim 9, wherein said means for generating a first image comprises an infrared sensor.

18. The apparatus of claim 9, wherein said means for generating a second image comprises a visible camera.

19. A computer-readable medium having stored thereon a plurality of instructions, the plurality of instructions including instructions which, when executed by a processor, cause the processor to perform the steps of a method for producing a fused image, comprising:
generating a first image at a first wavelength;
generating a second image at a second wavelength, wherein said second wavelength is different from said first wavelength;
generating range information;
warping said first image to correlate with said second image using said range information; and
fusing said warped first image with said second image to produce said fused image.

20. The computer-readable medium of claim 19, wherein said warping step comprises:
producing transformation data using said range information; and
warping said first image to correlate with said second image using said transformation data.
